(19) United States
(12) Patent Application Publication
(10) Pub. No.: US 2026/0302788 A1
(43) Pub. Date: Oct. 1, 2026

(54) INFORMATION PROCESSING DEVICE, METHOD, AND MOVABLE BODY

(71) Applicant: TOYOTA JIDOSHA KABUSHIKI KAISHA, Toyota-shi (JP)

(72) Inventors: Toru FURUSAWA, Yokohama-shi (JP); Hiroshi ABE, Kasukabe-shi (JP); Kazuya OKADA, Tokyo (JP); Tomoko MASUDA OKUZAWA, Tokyo (JP)

(73) Assignee: TOYOTA JIDOSHA KABUSHIKI KAISHA, Toyota-shi (JP)

(21) Appl. No.: 19/532,282

(22) Filed: Feb. 6, 2026

(30) Foreign Application Priority Data
Mar. 25, 2025 (JP) 2025-050428

(51) Int. Cl. H02J 3/32; H02J 3/00; H02J 3/38; B60L 53/60

(52) U.S. Cl. CPC H02J 3/322; H02J 3/004; H02J 3/38; B60L 53/60

(57) ABSTRACT

The information processing device includes a control unit. The control unit is configured to instruct a movable body including a storage battery and a group of computers configured to execute predetermined processing using the storage battery as a power source, (i) to move to a first location where a power generation facility that utilizes renewable energy is installed and where a surplus exists or is forecast to exist in an available power supply amount at the power generation facility, and (ii) to perform charging of the storage battery with renewable power from the power generation facility at the first location. The control unit is also configured to cause the group of computers to continue executing the predetermined processing while receiving power supply from the storage battery during movement of the movable body.

### CROSS-REFERENCE TO RELATED APPLICATION

This application claims priority to Japanese Patent Application No. 2025-050428 filed on Mar. 25, 2025. The disclosure of the above-identified application, including the specification, drawings, and claims, is incorporated by reference herein in its entirety.

### BACKGROUND

### 1. Technical Field

The present disclosure relates to power supply by a power generation facility that utilizes renewable energy.

2. Description of Related Art

A technique has been disclosed in which a requested amount of power interchange is received from another power supply area, a storage battery corresponding to the requested amount of power interchange is identified, and the identified storage battery is transported to the other power supply area to perform power interchange (for example, Japanese Unexamined Patent Application Publication No. 2013-90344 (JP 2013-90344 A)). In JP 2013-90344 A, while the vehicle equipped with the storage battery is moving, the storage battery does not supply power, and therefore the utilization efficiency of the storage battery may decrease.

### SUMMARY

An object of the present disclosure is to provide an information processing device, a method, and a movable body that can improve the utilization efficiency of a storage battery mounted on the movable body.

One aspect of the present disclosure is an information processing device including a control unit configured to instruct a movable body including a storage battery and a group of computers configured to execute predetermined processing using the storage battery as a power source, (i) to move to a first location where a power generation facility that utilizes renewable energy is installed and where a surplus exists or is forecast to exist in an available power supply amount at the power generation facility, and (ii) to perform charging of the storage battery with renewable power from the power generation facility at the first location, and

cause the group of computers to continue executing the predetermined processing while receiving power supply from the storage battery during movement of the movable body.

Another aspect of the present disclosure is a method including, by a computer:

instructing a movable body including a storage battery and a group of computers configured to execute predetermined processing using the storage battery as a power source, (i) to move to a first location where a power generation facility that utilizes renewable energy is installed and where a surplus exists or is forecast to exist in an available power supply amount at the power generation facility, and (ii) to perform charging of the storage battery with renewable power from the power generation facility at the first location; and

causing the group of computers to continue executing the predetermined processing while receiving power supply from the storage battery during movement of the movable body.

Still another aspect of the present disclosure is a movable body including:

a storage battery; and

a control unit configured to

determine (i) to perform movement to a first location where a power generation facility that utilizes renewable energy is installed and where a surplus exists or is forecast to exist in an available power supply amount at the power generation facility, and (ii) to perform charging of the storage battery with renewable power from the power generation facility at the first location, and

cause a group of computers mounted on the movable body and configured to execute predetermined processing using the storage battery as a power source, to continue executing the predetermined processing while receiving power supply from the storage battery during the movement of the movable body.

The present disclosure can improve the utilization efficiency of a storage battery mounted on a movable body.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows an example of the operation of a vehicle according to a first embodiment;

FIG. 2 shows an example of the hardware configuration of a control device;

FIG. 3 shows an example of the functional configuration of the control device; and

FIG. 4 shows an example of a flowchart of a process executed by the control device according to the first embodiment to determine a destination and control charging of a storage battery.

### DETAILED DESCRIPTION OF EMBODIMENTS

In one aspect of the present disclosure, a movable body transports a storage battery to a location where a power generation facility that utilizes renewable energy is installed and where a surplus exists in an available power supply amount at the power generation facility. The movable body is also equipped with a group of computers that uses the storage battery as a power source. By operating the group of computers with power supplied from the storage battery even during movement, the utilization efficiency of the storage battery is improved. More specifically, one aspect of the present disclosure is an information processing device including a control unit. The control unit is configured to instruct a movable body including a storage battery and a group of computers configured to execute predetermined processing using the storage battery as a power source, (i) to move to a first location where a power generation facility that utilizes renewable energy is installed and where a surplus exists or is forecast to exist in an available power supply amount at the power generation facility, and (ii) to perform charging of the storage battery with renewable power from the power generation facility at the first location. The control unit is also configured to cause the group of computers to continue executing the predetermined processing while receiving power supply from the storage battery during movement of the movable body.

The information processing device may be, for example, a dedicated or general-purpose computer operating as a server. However, the information processing device may alternatively be an in-vehicle device such as a data communication module (DCM) mounted on a vehicle, the vehicle, a smartphone, a personal computer (PC), or a tablet terminal. The control unit may be, for example, a processor such as a central processing unit (CPU) or a graphics processing unit (GPU), and a circuit such as a field-programmable gate array (FPGA). The movable body including the storage battery and the group of computers may be, for example, a vehicle such as a wagon, truck, or trailer, a railway vehicle, a ship, or an aircraft. The first location may be, for example, a location where a power generation facility that utilizes renewable energy and facilities that consume renewable power supplied from the power generation facility are installed. Examples of the facilities that consume renewable power supplied from the power generation facility include data centers, factories, commercial facilities, and residences. The first location may be an area having a geographical extent in which supply of renewable power from the power generation facility is available.

According to the above aspect of the present disclosure, since the group of computers continues executing the predetermined processing while receiving power supply from the storage battery even during movement of the movable body, the utilization efficiency of the storage battery can be improved. In addition, since the movable body moves to the first location and charges the storage battery with renewable power generated by the power generation facility, the utilization efficiency of the renewable power generated by the power generation facility can be improved.

In the above aspect of the present disclosure, the control unit may be configured to, after the movable body has arrived at the first location, (i) when no surplus is occurring in the available power supply amount at the first location, cause the group of computers to execute the predetermined processing while receiving power supply from the storage battery, and (ii) when a surplus is occurring or has occurred in the available power supply amount at the first location, cause the group of computers to execute the predetermined processing while receiving supply of the renewable power from the power generation facility, and cause the storage battery to be charged with the renewable power from the power generation facility. In this configuration, when a surplus is occurring or has occurred in the available power supply amount at the first location, both the storage battery and the group of computers in the movable body receive power supply from the power generation facility at the first location. This can facilitate elimination of the surplus in the available power supply amount at the first location.

The present disclosure can be specified, in another aspect, as a method in which a computer executes the processing executed by the above information processing device. The present disclosure can be specified, in other aspects, as a program for causing a computer to execute the above method, and as a non-transitory computer-readable recording medium on which the program is recorded. The present disclosure can be specified, in yet another aspect, a movable body including a storage battery and a control unit. The control unit is configured to determine (i) to perform movement to a first location where a power generation facility that utilizes renewable energy is installed and where a surplus exists or is forecast to exist in an available power supply amount at the power generation facility, and (ii) to perform charging of the storage battery with renewable power from the power generation facility at the first location. The control unit is also configured to cause a group of computers mounted on the movable body and configured to execute predetermined processing using the storage battery as a power source to continue executing the predetermined processing while receiving power supply from the storage battery during the movement of the movable body.

Hereinafter, embodiments of the present disclosure will be described with reference to the drawings. The configurations of the embodiments described below are merely illustrative, and the present disclosure is not limited to the configurations of the embodiments.

### First Embodiment

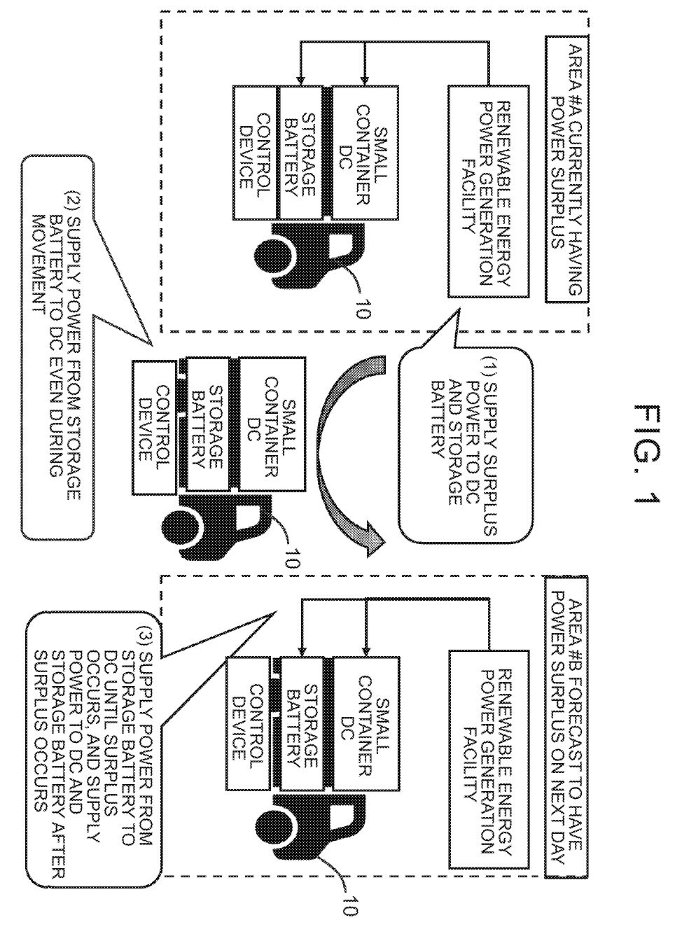

FIG. 1 shows an example of the operation of a vehicle 10 according to a first embodiment. The vehicle 10 includes a storage battery, a small container data center (DC), and a control device. The vehicle 10 may be, for example, a trailer, a truck, or a wagon. The vehicle 10 may be a gasoline vehicle, a diesel vehicle, a battery electric vehicle (EV), or a hybrid electric vehicle (HV). The vehicle 10 may be either a manually operated vehicle driven by a driver or an autonomous vehicle.

The small container DC uses the storage battery as one of its power sources. The small container DC includes, for example, one or more computers with communication functions, and executes predetermined processing. The small container DC includes at least one of the following: one or more processors (such as central processing units (CPUs) or graphics processing units GPUs), one or more storage devices (such as memory or storage), and one or more communication devices. The small container DC may include one or more sets that combine these components. However, the small container DC is not limited to these examples and may instead include a server rack in which a plurality of servers is installed. The small container DC is an example of the "group of computers."

The vehicle 10 is a vehicle capable of transporting electric power by moving between power generation areas and charging the storage battery 2 with surplus power generated by power generation facilities. The term "power generation area" refers to an area including a power generation facility that utilizes renewable energy and facilities that consume renewable power generated by the power generation facility. Examples of facilities that consume renewable power generated by the power generation facility include data centers, factories, commercial facilities, and residences. The power generation facility and the facilities that consume renewable power generated by the power generation facility may be installed at the same location or at separate locations. The term "power generation area" may refer to an area where renewable power supplied from the power generation facility that utilizes renewable energy can be used. The power generation facility may be any of solar, wind, hydro, or biomass power generation facilities. Hereinafter, electric power supplied from a power generation facility that utilizes renewable energy is also referred to as "renewable power." The vehicle 10 is an example of the "movable body."
(1) The vehicle 10 travels to a power generation area #A where a surplus of renewable power from a power generation facility that utilizes renewable energy is occurring, receives renewable power supply from the power generation facility, charges the storage battery, and causes the small container DC to execute processing. A "surplus of renewable power" refers to a state in which the amount of renewable power that can be supplied by the power generation facility exceeds the amount of power consumption. When the small container DC executes processing, the small container DC is said to be operating.
(2) The vehicle 10 then travels to a power generation area #B where a surplus of renewable power is forecast to occur during a forecast period in the near future, for example, the next day. Even during movement of the vehicle 10, the small container DC continues operating while receiving power supply from the storage battery.
(3) When the vehicle 10 arrives at power generation area #B, the small container DC continues operating while receiving power supply from the storage battery until a surplus of renewable power occurs. Once a surplus of renewable power occurs, the storage battery is charged with renewable power supplied from the power generation facility, and the small container DC operates using renewable power supplied from the power generation facility.

The control device controls the operation of the vehicle 10 as described in (1) to (3) above. In the first embodiment, the small container DC operates continuously regardless of whether the vehicle 10 is moving and whether the storage battery is being charged. This improves the utilization efficiency of the storage battery. In a power generation area where a surplus of renewable power occurs, renewable power is supplied to both the storage battery and the small container DC on the vehicle 10. Therefore, the surplus of renewable power can be reduced more quickly.

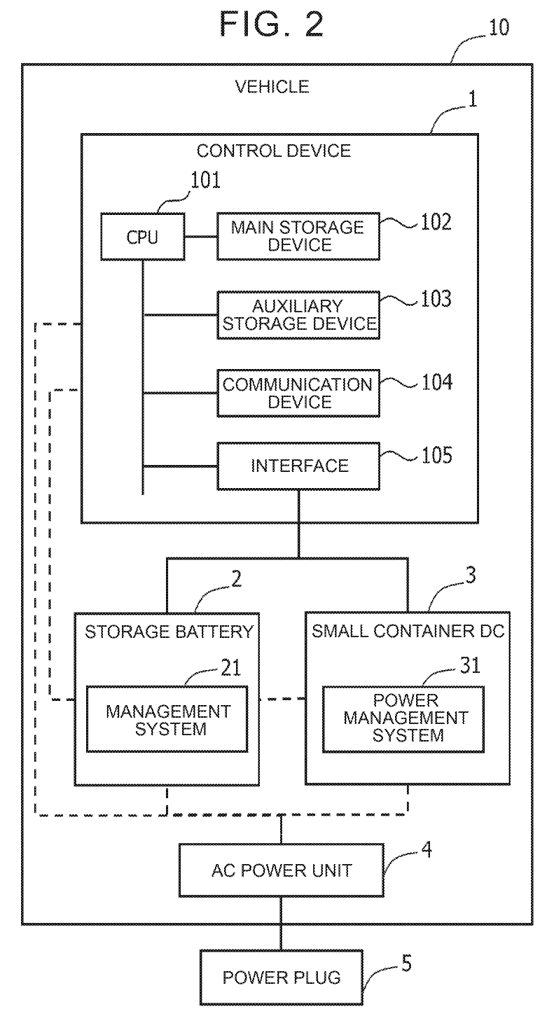

FIG. 2 shows an example of the hardware configuration of the control device 1. The control device 1 includes, as its hardware components, a processor 101, a main storage device 102, an auxiliary storage device 103, a communication device 104, and an interface 105. The main storage device 102 and the auxiliary storage device 103 are computer-readable recording media. The control device 1 is an example of the "information processing device."

The auxiliary storage device 103 stores various programs and data used by the processor 101 during execution of these programs. The auxiliary storage device 103 may be, for example, an erasable programmable read-only memory (EPROM), a hard disk drive (HDD), or a solid-state drive (SSD). The programs stored in the auxiliary storage device 103 include, for example, an operating system (OS), application programs, and programs for determining the destination of the vehicle 10, controlling charging of a storage battery 2, and controlling a small container DC 3.

The main storage device 102 is a storage device that provides the processor 101 with a storage area for loading programs stored in the auxiliary storage device 103 and a work area for execution, and that also serves as a buffer. The main storage device 102 may include, for example, semiconductor memory such as read-only memory (RAM) or random access memory (RAM).

The processor 101 executes various processes by loading programs stored in the auxiliary storage device 103 into the main storage device 102 and executing them. The processor 101 may be, for example, a central processing unit (CPU), a graphics processing unit (GPU), or a digital signal processor (DSP). The processor 101 is not limited to a single unit and may include multiple processors. The processor 101 is an example of the "control unit."

The communication device 104 connects to a wireless network and communicates with other devices. The communication device 104 may be, for example, a wireless local area network (LAN) card, or a wireless circuit that connects to a fifth-generation (5G), fourth-generation (4G), or post-fifth-generation (post-5G) mobile communication network. The interface 105 is an interface that connects to an in-vehicle network. Examples of the in-vehicle network include in-vehicle Ethernet and a controller area network (CAN).

The vehicle 10 also includes the storage battery 2 and the small container DC 3. The storage battery 2 and the small container DC 3 are connected to the in-vehicle network. The storage battery 2 includes a management system 21 that performs control such as charging control, discharging control, and temperature control of the storage battery 2. The small container DC 3 includes a power management system 31 that monitors the remaining capacity of the storage battery 2 and controls switching of power supply between the storage battery 2 and an alternating current (AC) power source. The management system 21 and the power management system 31 can communicate with the control device 1 via the in-vehicle network. In FIG. 2, signal lines are shown as continuous lines.

In FIG. 2, power connections are shown as dashed lines. The vehicle 10 also includes an alternating current (AC) power unit 4. A power plug 5 is connected to the AC power unit 4. When the power plug 5 is inserted into an outlet, the vehicle 10 is connected to the AC power source through the power plug 5, and alternating current flows through the AC power unit 4. The AC power unit converts the alternating current into direct current and supplies power to devices within the control device 1.

The control device 1 and the small container DC 3 are each connected to the storage battery 2 and the AC power unit 4 by power lines, and can receive power supply from either the storage battery 2 or the AC power unit 4. The power management system 31 in the small container DC 3 controls which power source, either the storage battery 2 or the AC power unit 4, is used to supply power. The storage battery 2 is connected to the AC power unit 4 by a power line and is charged with power supplied from the AC power source via the AC power unit 4. In the first embodiment, the power management system 31 switches the power source between the storage battery 2 and the AC power unit 4 according to instructions from the control device 1. In the first embodiment, the management system 21 starts charging according to instructions from the control device 1. When the vehicle 10 is a battery electric vehicle, the storage battery 2 may serve as the driving power source for the vehicle 10, or the vehicle 10 may be equipped with a separate storage battery for traction in addition to the storage battery 2.

The hardware configuration of the control device 1 shown in FIG. 2 is merely an example, and the hardware configuration of the control device 1 is not limited to the configuration shown in FIG. 2. The control device 1 may alternatively be a device including an electrical circuit such as a dedicated field-programmable gate array (FPGA) or application-specific integrated circuit (ASIC) that executes the relevant processes.

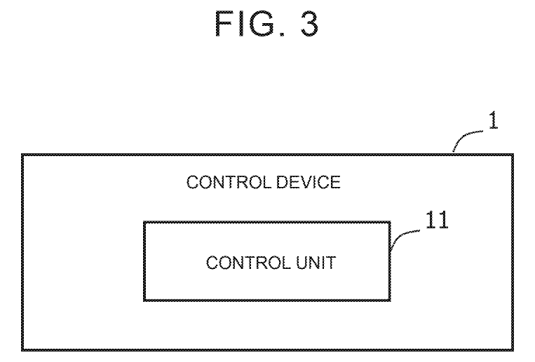

FIG. 3 shows an example of the functional configuration of the control device 1. In this functional configuration, the control device 1 includes a control unit 11. The functional components of the control device 1 are implemented by, for example, the processor 101 of the control device 1 executing a predetermined program.

The control unit 11 acquires information regarding a surplus of renewable power and information regarding a forecast of a surplus of renewable power for each power generation area including a power generation facility that utilizes renewable energy. A power generation area including a power generation facility that utilizes renewable energy is hereinafter referred to "power generation site." Information regarding the surplus of renewable power is hereinafter referred to as "power surplus information." Information regarding the forecast of the surplus of renewable power is hereinafter referred to as "power surplus forecast information." The surplus of renewable power is hereinafter simply referred to as "power surplus" or "surplus power."

The power surplus information includes, for example, information indicating whether a power surplus is occurring at a power generation site. The power surplus information may be acquired from, for example, a predetermined server. The power surplus information may be acquired from the predetermined server for power generation sites where a power surplus is occurring. Instead of information indicating whether a power surplus is occurring at a power generation site, the power surplus information may include, for example, the amounts of renewable power supplied and power consumed at each power generation site. In this case, the control unit 11 may determine, for each power generation site, whether a power surplus is occurring based on the relationship between the amount of renewable power supplied and the amount of power consumed.

The server that provides the power surplus information may be, for example, a server that monitors power surplus at each power generation site, a server that monitors the available power supply amount at each power generation site, a server that monitors power consumption at each power generation site, a server that manages information on each power generation site, or one or more servers that aggregate information from these servers. Alternatively, the control unit 11 may directly acquire information such as the available power supply amount and power consumption at each power generation site from servers that manage power at the respective power generation sites.

The power surplus forecast information may include, for example, information indicating whether a power surplus is forecast to occur at a power generation site during a future forecast period. The power surplus forecast information may be acquired from a predetermined server. The power surplus forecast information may be acquired from the predetermined server for power generation sites where a power surplus is forecast to occur.

Instead of information indicating whether a power surplus is forecast to occur at a power generation site, the power surplus forecast information may include, for example, the location of each power generation site, information on the power generation capacity of the power generation facility at each power generation site, information on power consumption at each power generation site, and weather information for each power generation site during a future forecast period. In this case, the control unit 11 may forecast, for each power generation site, the available renewable power supply amount during the forecast period based on the location, the information on the power generation capacity of the power generation facility, and the weather information during the forecast period, and may determine, based on the forecast result and the information on power consumption, whether a power surplus is forecast to occur during the forecast period. Information on the power generation capacity of the power generation facility may include, for example, one or more of the following: rated output, maximum power generation capacity representing instantaneous power generation capability, average generated power, operating time, and power generation efficiency. Information on power consumption may include, for example, one or more of the following: the total power consumption per unit time, such as per hour, and the power consumption by time period, in facilities such as data centers or factories located at the power generation site. The server that provides the power surplus forecast information may be, for example, a server that manages information on each power generation site, a server that forecasts the available renewable power supply amount at each power generation site, a server that forecasts the power surplus at each power generation site, or one or more servers that aggregate information from these servers.

The forecasting of the available renewable power supply amount may be performed, for example, using a predetermined method or a machine learning model, based on information regarding the power generation facility and weather forecast information. The method for forecasting the available renewable power supply amount is not limited to any specific method.

The forecast period may be, for example, a predetermined future period such as the following day, several days later, or the following week. When the renewable energy is solar power, the forecast period may be fixed to a time range such as from 7:00 a.m. to 5:00 p.m. on the following day, or may vary daily, for example, from the forecast sunrise time to the forecast sunset time. The forecast period may correspond to a time period in which the power consumption at the power generation site is high. As a forecast result of the available renewable power supply amount, for example, the available supply amount per predetermined unit time, such as every 30 minutes or every hour, during the forecast period may be obtained, or the total available supply amount for the entire forecast period may be obtained.

The power surplus forecast indicates that the forecast value of the available renewable power supply amount exceeds a threshold relative to the maximum power consumption of the power generation facility at the power generation site. The threshold relative to the maximum power consumption of the power generation facility at the power generation site may be expressed as, for example, a percentage of the maximum power consumption. For example, at a power generation site where electric power supplied by a power company and renewable power generated by a power generation facility utilizing renewable energy are used together as power sources, when the upper limit of the utilization rate of renewable power is set to 50%, 50% of the maximum power consumption serves as the threshold for the power surplus forecast. However, the definition of the power surplus forecast is not limited to this.

The power surplus information and the power surplus forecast information may be acquired from different servers or from the same server. The power surplus information and the power surplus forecast information may be acquired at different timings or at the same timing.

When a power generation site where a power surplus is occurring is present within a range in which the vehicle 10 can travel with its remaining energy amount, the control unit 11 determines to move the vehicle 10 to that power generation site. When no power generation site where a power surplus is occurring is present within a range in which the vehicle 10 can travel with its remaining energy amount, but a power generation site where a power surplus is forecast to occur is present within that range, the control unit 11 determines to move the vehicle 10 to that power generation site. The range in which the vehicle 10 can travel with its remaining energy amount can be obtained from the remaining amount of gasoline or diesel fuel and the fuel efficiency when the vehicle 10 is a gasoline or diesel vehicle, and from the remaining capacity of the traction storage battery and the power consumption rate when the vehicle 10 is a battery electric vehicle.

In addition to the range in which the vehicle 10 can travel with its remaining energy amount, the control unit 11 may determine the destination power generation site for the vehicle 10 within a range in which the vehicle 10 can travel during a time period in which the small container DC 3 can operate with the remaining capacity of the storage battery 2. This reduces the possibility that the remaining capacity of the storage battery 2 may reach zero during movement of the vehicle 10. Accordingly, the operation of the small container DC 3 becomes less likely to stop, thereby improving the operation rate of the small container DC 3. The time period during which the small container DC 3 can operate can be obtained from, for example, the remaining capacity of the storage battery 2 and the power consumption of the small container DC 3. The range in which the vehicle 10 can travel during the time period in which the small container DC 3 can operate with the remaining capacity of the storage battery 2 can be obtained by, for example, setting the speed of the vehicle 10 to a predetermined value. When the vehicle 10 is a battery electric vehicle and the storage battery 2 is used as a traction storage battery for the vehicle 10, the amount of power consumed by the small container DC 3 during movement is also taken into account.

When the control unit 11 determines the destination power generation site, it sends an instruction to a device associated with the vehicle 10 to move to the destination power generation site. The device associated with the vehicle 10 may be, for example, a car navigation device, a user terminal such as a smartphone used by a driver, or, when the vehicle 10 is an autonomous vehicle, a device that controls traveling of the vehicle 10. Along with the instruction to move to the destination power generation site, information on a charging position at the destination power generation site is also sent. The vehicle 10 travels using the charging position as the destination. The charging position is a location where a power generation facility at the destination power generation site, or equipment and outlets that can receive power supply from the power generation facility, are installed.

The control unit 11 also controls charging of the storage battery 2, operation of the small container DC 3, and power supply to the small container DC 3. Regardless of the traveling state of the vehicle 10, such as whether it is moving or stopped, the control unit 11 keeps the small container DC 3 operating except when there is no power source, such as when the remaining capacity of the storage battery 2 is zero and the vehicle 10 is not connected to the AC power source. When the vehicle 10 is not connected to the AC power source, the control unit 11 sets the storage battery 2 as the power source of the small container DC 3 and causes the small container DC 3 to receive power supply from the storage battery 2.

When the vehicle 10 arrives at a power generation site, the power plug 5 is inserted into an outlet at the power generation site, thereby connecting the vehicle 10 to the AC power source. The insertion of the power plug 5 of the vehicle 10 into the outlet at the power generation site may be performed by, for example, a driver of the vehicle 10 or by staff present at the power generation site. After the vehicle 10 arrives at the power generation site, the control unit 11 periodically acquires, at predetermined intervals, information regarding power surplus from a server that manages power at the power generation site. The information regarding power surplus may include, for example, the available renewable power supply amount and the power consumption, or the surplus amount of electric power. Whether the vehicle 10 has arrived at the power generation site may be determined, for example, based on the positional information of the vehicle 10 and the power generation site, or based on the fact that the power plug 5 has been inserted into the outlet and the vehicle 10 has been connected to the AC power source at the power generation site.

When a power surplus has not occurred at the power generation site where the vehicle 10 is currently located, the control unit 11 sets the storage battery 2 as the power source of the small container DC 3 and causes the small container DC 3 to receive power supply from the storage battery 2. When a power surplus has occurred or is occurring at the power generation site where the vehicle 10 is currently located, the control unit 11 instructs the storage battery 2 to start charging with power from the AC power source. In this case, the control unit 11 also sets the AC power source as the power source of the small container DC 3 and causes the small container DC 3 to receive power supply from the AC power unit 4. The control unit 11 may start charging the storage battery 2 from the AC power source when, for example, the remaining capacity of the storage battery 2 falls below a predetermined threshold and the vehicle 10 is connected to the AC power source.

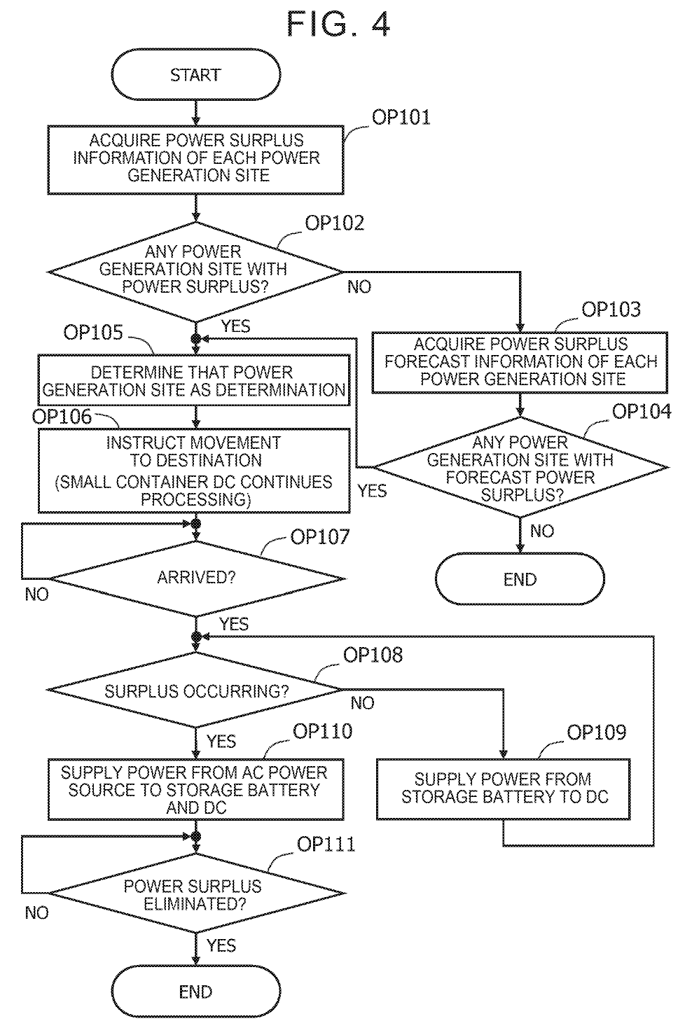

FIG. 4 shows an example of a flowchart of a process executed by the control device 1 according to the first embodiment to determine a destination and control charging of the storage battery 2. The process shown in FIG. 4 is repeatedly executed, for example, at predetermined intervals. The execution cycle of the process shown in FIG. 4 may be, for example, 10 minutes, 15 minutes, 30 minutes, or one hour, and can be set as desired by an administrator of the vehicle 10. The process shown in FIG. 4 is executed by the processor 101 of the control device 1. However, for convenience of description, the functional components are described as the entities executing the process.

In OP101, the control unit 11 acquires power surplus information of each power generation site. In OP102, the control unit 11 determines, based on the power surplus information of each power generation site, whether there is any power generation site where a power surplus is occurring within a range in which the vehicle 10 can travel. When there is a power generation site where a power surplus is occurring within the range in which the vehicle 10 can travel (OP102: YES), the process proceeds to OP105. When there is no power generation site where a power surplus is occurring within the range in which the vehicle 10 can travel (OP102: NO), the process proceeds to OP103.

In OP103, the control unit 11 acquires power surplus forecast information of each power generation site. In OP104, the control unit 11 determines, based on the power surplus forecast information of each power generation site, whether there is any power generation site where a power surplus is forecast to occur within the range in which the vehicle 10 can travel. When there is a power generation site where a power surplus is forecast to occur within the range in which the vehicle 10 can travel (OP104: YES), the process proceeds to OP105. When there is no power generation site where a power surplus is forecast to occur within the range in which the vehicle 10 can travel (OP104: NO), the process shown in FIG. 4 ends, and the vehicle 10 remains at its current position.

In OP105, the control unit 11 determines, as a destination, a power generation site where a power surplus is occurring or a power generation site where a power surplus is forecast to occur within the range in which the vehicle 10 can travel. For example, when there is a plurality of power generation sites where a power surplus is occurring or a plurality of power generation sites where a power surplus is forecast to occur within the range in which the vehicle 10 can travel, the control unit 11 may determine, as the destination, for example, the nearest power generation site, the farthest power generation site, the power generation site with the largest amount or forecast amount of surplus renewable power, or a randomly selected power generation site.

In OP106, the control unit 11 instructs the vehicle 10 to move to the determined destination power generation site. For example, when the vehicle 10 is a vehicle that travels under operation by a driver, the control unit 11 sends a movement instruction to a navigation system installed in the vehicle 10 or a user terminal of the driver. For example, when the vehicle 10 is an autonomous vehicle, the control unit 11 sends a movement instruction to a control device that controls traveling of the vehicle 10. Along with the movement instruction, information such as positional information of the destination power generation site is also sent. Even after the vehicle 10 starts traveling, the control unit 11 keeps the small container DC 3 operating with power supplied from the storage battery 2. When the power plug 5 of the vehicle 10 is inserted into an outlet at the current location before movement of the vehicle 10, the power plug 5 is removed from the outlet by the driver of the vehicle 10 or by staff present at the current location. When the power generation site at which the vehicle 10 is currently located is determined as the destination power generation site in OP105, a stop instruction is sent in OP106, or no movement instruction is sent.

In OP107, the control unit 11 determines whether the vehicle 10 has arrived at the destination power generation site. When the vehicle 10 has arrived at the destination power generation site (OP107: YES), the process proceeds to OP108. When the vehicle 10 has not yet arrived at the destination power generation site (OP107: NO), OP107 is repeatedly executed. Thereafter, while the vehicle 10 is located at the power generation site, the control unit 11 periodically acquires, at predetermined intervals, information regarding power surplus at the destination power generation site.

In OP108, the control unit 11 determines, based on the information regarding power surplus at the destination power generation site, whether a power surplus is occurring. When a power surplus is occurring at the destination power generation site (OP108: YES), the process proceeds to OP110. When a power surplus is not occurring at the destination power generation site (OP108: NO), the process proceeds to OP109.

In OP109, the control unit 11 keeps the small container DC 3 executing predetermined processing with power supplied from the storage battery 2. In OP110, the control unit 11 sets the AC power source as the power source of the storage battery 2 and the small container DC 3, starts charging the storage battery 2 with power from the AC power source, and keeps the small container DC 3 executing the predetermined processing with power supplied from the AC power source.

In OP111, the control unit 11 determines whether the power surplus at the power generation site where the vehicle 10 is currently located has been eliminated. The state in which the power surplus at the power generation site has been eliminated may be, for example, a state in which the surplus amount of available renewable power supply has become less than or equal to a predetermined threshold, or a state in which the available renewable power supply amount is less than the power consumption. The elimination of the power surplus at the power generation site may be determined based on, for example, information regarding power surplus at the power generation site. When the power surplus at the power generation site where the vehicle 10 is currently located has been eliminated (OP111: YES), the process shown in FIG. 4 ends. OP111 is repeatedly executed until the power surplus at the power generation site where the vehicle 10 is currently located has been eliminated (OP111: NO).

When the power surplus has not been eliminated even after completion of charging of the storage battery 2, the small container DC 3 may continue operating using the AC power source as its power source, and the surplus renewable power may thus be consumed by the small container DC 3. This can facilitate elimination of the power surplus at the power generation site where the vehicle 10 is currently located. Alternatively, after charging of the storage battery 2 is completed, the control unit 11 may switch the power source of the small container DC 3 to the storage battery 2. In this case, when the remaining capacity of the storage battery 2 falls below the predetermined threshold, the control unit 11 may start charging the storage battery 2 again and switch the power source of the small container DC 3 to the AC power source. This can improve the utilization efficiency of the storage battery 2.

The process executed by the control device 1 to determine the destination and control charging of the storage battery 2 is not limited to the process shown in FIG. 4. For example, when charging of the storage battery 2 has been completed, the control device 1 may determine to move the vehicle 10 to another power generation site where a power surplus is occurring or is forecast to occur, regardless of whether the power surplus at the current power generation site has been eliminated.

### Functions and Effects of First Embodiment

In the first embodiment, the vehicle 10 that transports the storage battery 2 to a power generation site where a power surplus is occurring to carry out power transfer is equipped with the small container DC 3, and the small container DC 3 operates using power supplied from the storage battery 2 even during movement of the vehicle 10. This improves the utilization efficiency of the storage battery 2.

### Other Embodiments

The embodiment described above is merely an example, and the present disclosure may be modified as appropriate without departing from the spirit and scope of the disclosure.

The first embodiment is described on the assumption that the vehicle 10 moves between power generation sites each equipped with a power generation facility that utilizes renewable energy. However, the present disclosure is not limited to this, and the process for determining the destination described in the first embodiment can also be applied to cases where the vehicle 10 moves between power generation sites including a power generation site equipped with a non-renewable energy power generation facility. Examples of non-renewable energy include oil, natural gas, and coal.

In the first embodiment, the control device 1 mounted on the vehicle 10 determines the destination of the vehicle 10. Alternatively, a predetermined server included in a system including a plurality of vehicles 10 may determine the destination of the vehicle 10. When the predetermined server determines the destination of the vehicle 10, for example, the predetermined server may execute OP101 to OP106 in FIG. 4 of the first embodiment, and the control device 1 of the vehicle 10 may execute OP107 to OP111 in FIG. 4. When there is a plurality of power generation sites where a power surplus is occurring, the predetermined server may cause the vehicles 10 to move to one of the power generation sites where a power surplus is occurring, or conversely, may distribute the vehicles 10 among the plurality of power generation sites where a power surplus is occurring.

In the first embodiment, the vehicle 10 performs transportation of the storage battery 2. However, the present disclosure is not limited to this. The transportation of the storage battery 2 may alternatively be performed by another movable body such as a railway vehicle, a ship, or an aircraft. In this case, the movable body is provided with the small container DC 3.

The processes and means described in the present disclosure may be combined as desired as long as no technical inconsistency arises.

Processing described as being executed by a single device may be divided and executed by a plurality of devices. Alternatively, processing described as being executed by different devices may instead be executed by a single device. In a computer system, the hardware configuration (server configuration) used to implement each function may be flexibly modified.

The present disclosure may also be implemented by supplying a computer program that implements the functions described in the above embodiments to a computer, and causing one or more processors included in the computer to read and execute the program. Such a computer program may be provided to the computer via a non-transitory computer-readable storage medium connectable to a system bus of the computer, or may be provided to the computer via a network. The non-transitory computer-readable storage medium may include, for example, any type of disk such as a magnetic disk (floppy (registered trademark) disk, hard disk drive (HDD), etc.) or an optical disc (compact disc read-only memory (CD-ROM), digital versatile disc (DVD), Blu-ray disc, etc.), a read-only memory (ROM), a random access memory (RAM), an erasable programmable read-only memory (EPROM), an electrically erasable programmable read-only memory (EEPROM), a magnetic card, a flash memory, an optical card, or any type of medium suitable for storing electronic instructions.

What is claimed is:

1. An information processing device comprising a control unit configured to
instruct a movable body including a storage battery and a group of computers configured to execute predetermined processing using the storage battery as a power source, (i) to move to a first location where a power generation facility that utilizes renewable energy is installed and where a surplus exists or is forecast to exist in an available power supply amount at the power generation facility, and (ii) to perform charging of the storage battery with renewable power from the power generation facility at the first location, and
cause the group of computers to continue executing the predetermined processing while receiving power supply from the storage battery during movement of the movable body.

2. The information processing device according to claim 1, wherein the control unit is configured to, after the movable body has arrived at the first location,
(i) when no surplus is occurring in the available power supply amount at the first location, cause the group of computers to execute the predetermined processing while receiving power supply from the storage battery, and
(ii) when a surplus is occurring or has occurred in the available power supply amount at the first location, cause the group of computers to execute the predetermined processing while receiving supply of the renewable power from the power generation facility, and cause the storage battery to be charged with the renewable power from the power generation facility.

3. The information processing device according to claim 1, wherein:
a driving power source of the movable body is the storage battery, and
the control unit is further configured to determine movement to a second location when a surplus amount of the available power supply amount becomes less than or equal to a predetermined threshold as a result of charging the storage battery with the renewable power from the power generation facility at the first location, the second location being located within a range reachable by the movable body with a remaining capacity of the storage battery, the second location being a location where a power generation facility that utilizes renewable energy is installed and where a surplus exists or is forecast to exist in an available power supply amount at the power generation facility.

4. A method comprising, by a computer:
instructing a movable body including a storage battery and a group of computers configured to execute predetermined processing using the storage battery as a power source, (i) to move to a first location where a power generation facility that utilizes renewable energy is installed and where a surplus exists or is forecast to exist in an available power supply amount at the power generation facility, and (ii) to perform charging of the storage battery with renewable power from the power generation facility at the first location; and
causing the group of computers to continue executing the predetermined processing while receiving power supply from the storage battery during movement of the movable body.

5. A movable body comprising:
a storage battery; and
a control unit configured to
determine (i) to perform movement to a first location where a power generation facility that utilizes renewable energy is installed and where a surplus exists or is forecast to exist in an available power supply amount at the power generation facility, and (ii) to perform charging of the storage battery with renewable power from the power generation facility at the first location, and
cause a group of computers mounted on the movable body and configured to execute predetermined processing using the storage battery as a power source to continue executing the predetermined processing while receiving power supply from the storage battery during the movement of the movable body.
